(19) United States
(12) Patent Application Publication
(10) Pub. No.: US 2024/0262751 A1
(43) Pub. Date: Aug. 8, 2024

(54) COLOURED ARTICLE AND METHOD FOR MANUFACTURING SAME

(71) Applicant: The Swatch Group Research and Development Ltd, Marin (CH)

(72) Inventors: Marta FORNABAIO, Crissier (CH); Lucie TABARD, Neuchâtel (CH); Arnaud ACTIS-DATTA, Bassecourt (CH)

(73) Assignee: The Swatch Group Research and Development Ltd, Marin (CH)

(21) Appl. No.: 18/420,329

(22) Filed: Jan. 23, 2024

(30) Foreign Application Priority Data
Feb. 7, 2023 (EP) 23155438.7

(51) Int. Cl. C04B 35/48; C04B 35/626; C04B 35/632; C04B 35/638; C04B 35/64

(52) U.S. Cl. CPC C04B 35/48; C04B 35/62695; C04B 35/632; C04B 35/638; C04B 35/64; C04B 2235/3217; C04B 2235/3225; C04B 2235/3246; C04B 2235/3248; C04B 2235/3275; C04B 2235/6567; C04B 2235/6581; C04B 2235/9661

(57) ABSTRACT

A coloured article made of a ceramic and including: a high-performance zirconia, present at between 80% and 99.5% by weight based on the total weight of the ceramic, pigments, present at between 2.5% and 20% by weight based on the total weight of the ceramic, and containing one or more oxides selected from the list consisting of Al, Si, Fe, Cu, Co, Ni, Mn, Zn, Cr, Ce, V, Nd, Pr and Ti oxides, including mixed oxides from this list. The total percentage by weight of the high-performance zirconia, pigments and any impurities are 100%, and the ceramic has a hardness HV30 greater than 1100 HV and a toughness greater than 12 MPav√m. Also, a method for manufacturing this article.

### CROSS REFERENCE TO RELATED APPLICATIONS

This application is claiming priority based on European Patent Application No. 23155438.7 filed on Feb. 7, 2023.

### TECHNICAL FIELD OF THE INVENTION

The present invention relates to a coloured article and in particular to an external timepiece component or movement component made from a zirconia-based material. It further relates to the method for manufacturing said article.

### Technological Background

Ceramics are commonly used in the watchmaking industry, particularly for external components, due to their high hardness which guarantees that they will not become scratched. Consequently, toughness tends to be more moderate with values typically not exceeding 6 or 7 MPav√m. These values can prove low for certain components that require higher toughness. Indeed, toughness can be correlated with part strength, where high toughness results in a lower probability of part breakage. Higher toughness can thus be expected to reduce production scrap and make parts easier to machine. In the case of external components, this would allow thin dials to be machined without risk of fracturing.

Ceramics used for decorative articles must further meet aesthetic criteria. As standard, ceramics with a zirconia matrix have a translucent whitish colour that is not particularly attractive. They are typically coloured with pigments to improve their aesthetic appearance. However, the colours obtained are often pale and/or non-homogeneous.

### SUMMARY OF THE INVENTION

The purpose of the present invention is to overcome the aforementioned drawbacks by proposing a new zirconia-based ceramic composition that makes it possible to manufacture an article with high hardness combined with high toughness, while at the same time having an intense and homogeneous colour throughout the volume of the article.

To this end, the present invention proposes to use so-called high-performance zirconia, the term “high-performance” referring to its high hardness and toughness, and to colour it with pigments or mixtures of pigments in very specific percentages to obtain this homogeneous and intense colour.

More specifically, the present invention relates to a coloured article made of a ceramic containing:
a so-called high-performance zirconia, present at between 80% and 99.5% by weight based on the total weight of the ceramic, the high-performance zirconia being selected from one or more of the following zirconias:
an yttrium oxide-doped zirconia, the molar percentage of yttrium oxide relative to the zirconia being less than 2.7%,
a cerium oxide and yttrium oxide co-doped zirconia, the total molar percentage of the cerium oxide with the yttrium oxide relative to the zirconia being between 1 and 12%,
a hafnium oxide and yttrium oxide co-doped zirconia, the total molar percentage of the hafnium oxide with the yttrium oxide relative to the zirconia being between 4 and 8%,
a zirconia doped with one or more oxides selected from an yttrium oxide, a cerium oxide, a magnesium oxide and a calcium oxide, and reinforced with an alumina, the percentage by weight of the alumina relative to the doped zirconia being between 8 and 18%,
pigments, present at between 2.5% and 20% by weight based on the total weight of the ceramic, said pigments containing one or more oxides selected from the list consisting of Al, Si, Fe, Cu, Co, Ni, Mn, Zn, Cr, Ti, V, Ce, Pr and Nd oxides, including mixed oxides from this list,
any impurities present at between 0 and 0.2% by weight, the total percentage by weight of the high-performance zirconia, pigments and any impurities being 100%, said ceramic having a hardness HV30 greater than 1100 HV and a toughness greater than 12 MPav√m.

Dials were made using these ceramic compositions. The results showed that the dials had an intense, perfectly homogeneous colour with no halos or marks. The colours obtained are shades of blue, black and white respectively. All of the samples have hardnesses greater than 1150 HV30 for a toughness greater than or equal to 12.5 MPav√m.

The present invention further relates to the method for manufacturing the article. More specifically, it relates to the manufacturing method comprising the following steps:
Step a): Preparing a base mixture, also referred to as the first mixture, with the high-performance zirconia and the pigments at the above-mentioned proportions, optionally in a liquid medium,
Optional step b): Producing a second mixture comprising the first mixture and an organic binder system,
Step c) if step b) is carried out: Granulating the second mixture,
Step d): Forming a bank in the shape of the article,
Step e): Removing the binder from the blank,
Step f): Sintering the blank, preferably in air, at a holding temperature of between 1200° C. and 1600° C., preferably between 1250° C. and 1450° C., for a period of between 20 minutes and 20 hours, preferably between 1 hour and 3 hours.

This method, based on powder technology with conventional sintering, is easy to industrialise, which is a significant advantage.

Other features and advantages of the invention will be better understood upon reading the following detailed description given with reference to the accompanying drawing.

### BRIEF DESCRIPTION OF THE FIGURE

FIG. 1 shows a dial made from the ceramic material according to the invention.

### DETAILED DESCRIPTION OF THE INVENTION

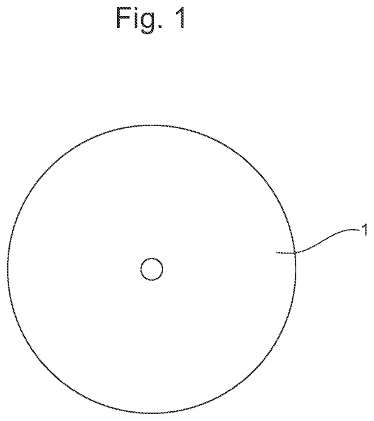

The present invention relates to an article made of a zirconia-based ceramic material. The article can be a decorative article such as a component of watches, jewellery, bracelets, etc. or, more generally, an external part of a portable element such as a mobile phone case. In the field of watchmaking, this article can be an external component such as a middle, a back, a bezel, a push-piece, a crown, a bracelet link, a dial, a hand, or a dial index, etc. By way of illustration, a dial 1 made from the ceramic material according to the invention is shown in FIG. 1. It can also be a component of the movement, such as a plate, a bridge, a wheel, an arbor or an oscillating weight.

The ceramic article according to the invention comprises a zirconium oxide (ZrO₂) matrix, also referred to as zirconia, made of a so-called high-performance zirconia. The term “high performance” is understood to mean one of the four zirconias listed below or a mixture of at least two of the zirconias listed below. It can be a zirconia doped with a low quantity of yttrium oxide (Y₂O₃), the molar percentage of yttrium oxide relative to the zirconia being less than 2.7%. It can be a cerium oxide (Ce₂O₃) and yttrium oxide (Y₂O₃) co-doped zirconia, the molar percentage of the cerium oxide with the yttrium oxide relative to the zirconia being between 1 and 12%. It can be a hafnium oxide (HfO₂) and yttrium oxide (Y₂O₃) co-doped zirconia, the molar percentage of the hafnium oxide with the yttrium oxide relative to the zirconia being between 4 and 8%. It can be a zirconia reinforced with alumina, referred to as ATZ or “alumina-toughened zirconia”, with a percentage by weight of alumina relative to the zirconia of between 8 and 18%. This alumina-reinforced zirconia is also doped, or in other words stabilised, with one or more oxides selected from yttrium oxide, cerium oxide, magnesium oxide and calcium oxide. Preferably, it is doped with cerium and yttrium oxides, present at between 4 and 8% by weight relative to the alumina-reinforced zirconia.

According to the invention, the high-performance zirconia is present at between 80 and 99.5% by weight, preferably between 80% and 97.5% by weight, more preferably between 88% and 97% by weight, and even more preferably between 89% and 96.5% by weight based on the total weight of the ceramic. According to the invention, the ceramic further includes pigments that give colour to the high-performance zirconia. These pigments are present at between 0.5% and 20% by weight, preferably between 2.5% and 20% by weight, more preferably between 3% and 12% by weight, and even more preferably between 3.5% and 11% by weight. The pigments are chosen from metal oxides and/or rare earth oxides. Preferably, these are one or more oxides chosen from Al, Si, Fe, Cu, Co, Ni, Mn, Zn, Cr, Ti, V, Ce, Nd and Pr oxides, including mixed oxides such as CoAl₂O₄. The ceramic can optionally contain impurities at between 0 and 0.2% by weight.

Preferably, the article consists of high-performance zirconia, pigments and any impurities present in the above-mentioned proportions.

The choice of pigments and their percentage depends on the colour required and its intensity. When blue or black colours are required, the pigments contain one or more oxides chosen from the list consisting of Al, Fe, Co, Cr, Ni and Mn oxides, including mixed oxides, at between 3 and 7% by weight in total.

Preferably, for the black colour, the pigments contain (are formed by) Co, Fe and Cr oxides including mixed oxides with between 3% and 6% by weight, preferably between 3% and 5% by weight, and more preferably between 3.5% and 4.5% by weight of total pigments. The black-coloured ceramic article has an intense colour with, in the CIELAB colour space (in accordance with CIE No. 15, ISO 7724/1, DIN 5033 Teil 7, ASTM E-1164 standards), an L* component greater than 40, more precisely between 42 and 50, where L is a measure of the lightness of black. The a* and b* components are around 0 for black. Advantageously, the high-performance zirconia used is zirconia lightly doped with yttrium oxide because it gives the best results from an aesthetic point of view.

Preferably, for the blue colour, the pigments contain (are formed by) Co and Al oxides including mixed oxides with between 3% and 7% by weight, preferably between 3% and 6% by weight, and more preferably between 3.5% and 5.5% by weight of total pigments. The blue colour is intense with an L component greater than 40, more precisely between 42 and 55. Advantageously, the high-performance zirconia is zirconia doped with one or more oxides chosen from yttrium oxide, cerium oxide, magnesium oxide and calcium oxide and reinforced with alumina. According to another advantageous alternative embodiment, the high-performance zirconia is zirconia co-doped with hafnium oxide and yttrium oxide.

When a green colour is required, the mixture is made by adding Ni and Cr oxides, including mixed oxides, at between 2.5% and 5% by weight.

When an intense, opaque white colour is required, the pigments contain Al and/or Ti oxides, including mixed oxides, at between 5 and 20% by weight. Preferably, the pigments contain (are formed by) Al oxide at between 6% and 14% by weight, preferably between 8% and 12% by weight, and more preferably between 9% and 11% by weight. Advantageously, the high-performance zirconia is zirconia lightly doped with yttrium oxide. It should be noted that the addition of cerium oxide as a doping or co-doping element is preferably avoided for the white colour, as cerium oxide contributes a yellowish tone that needs to be corrected. The white-coloured ceramic article has an L component greater than 90, or even greater than or equal to 95. The a* and b* components are around 0 for white.

The ceramic article has a hardness HV, more precisely HV30, greater than 1100, or even greater than 1150. It has a toughness Kᵢc greater than 12 MPav√m, preferably greater than or equal to 12.5 MPav√m, or even greater than or equal to 14 MPav√m. Typically, a toughness of between 12 MPav√m and 13 MPav√m is obtained for high-performance zirconia reinforced with alumina, while a toughness of between 13.5 MPav√m and 16 MPav√m is obtained for high-performance zirconia lightly doped with yttrium oxide and for high-performance zirconia co-doped with yttrium oxide and hafnium oxide.

The article is manufactured by sintering with the method consisting of:
Step a): Producing the basic mixture, also referred to as the first mixture, using the various compounds mentioned above, i.e. high-performance zirconia and pigments, possibly in a liquid medium. When the mixture is produced in a liquid medium, this occurs using dispersants, e.g. Dolapix CE 64, and milling balls, e.g. made of alumina or zirconia. Milling is carried out with an attritor or ball mill for between 15 minutes and 24 hours, depending on the composition. The quality of the dispersion is checked by laser granulometry with target d90 values of less than 0.9 μm, preferably less than 0.5 μm, more preferably less than 0.2 μm.
Optional step b): Producing a second mixture comprising the first mixture and an organic binder system (paraffin, polyethylene, polyvinyl acetate, etc.).
Step c) if step b) is carried out: Granulating and, if necessary, drying said second mixture, for example, in an atomiser. Preferably, the aggregates have a size d50 of between 10 and 100 μm, and preferably between 40 and 60 μm.
Step d): Forming a blank by shaping the first mixture, or the second mixture if step b) is carried out, into the desired article shape, for example, by injection moulding or pressing. The blank can also be made by casting, in which case steps b) and c) are not carried out.
Step e): Removing the binder from the blank in a temperature range of between 400° C. and 800° C., preferably between 550° C. and 650° C., typically with a holding time of between 2 hours and 4 hours. This could further involve solvent debinding in the case of injection moulding.
Step f): Sintering the blank, preferably in air, at a holding temperature of between 1200° C. and 1600° C., preferably between 1250° C. and 1450° C., for a period of between 20 minutes and 20 hours, preferably between 1 hour and 3 hours.

Depending on the colour required, sintering can be followed by heat treatment in a vacuum or controlled atmosphere, for example argon or nitrogen or reducing or oxidising gases, at a temperature of between 900° C. and 1200° C. with a plateau of between 20 minutes and 6 hours.

The resulting blank is cooled. It can then be machined, polished and decorated if necessary to obtain the desired article. As the colour is present throughout the thickness of the blank, these finishing operations do not alter the final colour of the article.

Tests were carried out on the compositions listed in table 1 below at sintering temperatures of between 1300° C. and 1500° C. for a holding time of 2 hours. It should be noted that the compositions can contain impurities present in the base compounds (high-performance zirconia and pigments) supplied. The hardness measurements are HV30 hardness measurements, i.e. carried out under a load of 30 kg. Toughness was determined on the basis of crack length measurements at the four ends of the diagonals of the hardness impression according to the formula:

$${K}_{1 C} = 0.0319 \frac{P}{{al}^{1 / 2}}$$

where P is the applied load (N), a is the diagonal half-length (m) and / is the measured crack length (m).

Lab colorimetric values were measured on polished samples using a KONICA MINOLTA CM-3610A spectrophotometer under the following conditions: SCI (specular component included) and SCE (specular component excluded) measurements, 8° inclination, 4 mm diameter SAV measurement area.

The samples obtained have an intense black, blue or white colour, with different shades of blue up to dark blue. All of the hardness values are greater than 1190 HV30. All of the toughness values are greater than or equal to 12.5 MPa √m, even with values greater than or equal to 14 MPa √m for zirconia matrices with a low yttrium oxide content or co-doped with yttrium oxide and hafnium oxide.

TABLE•1¶
¶

| | Example•A¶ | Example•B¶ | Example•C¶ | Example•D¶ | Example•E¶ | |
|---|---|---|---|---|---|---|
| | Ceramic•¶ | Ceramic¶ | Ceramic•¶ | Ceramic•¶ | Ceramic•¶ | |
| ¤ | Black¤ | Blue¤ | Bright•blue¤ | Dark•blue¤ | White¤ | ¤ |
| Composition•¤ | ¤ | ¤ | ¤ | ¤ | ¤ | ¤ |
| Zirconia•matrix¤ | ZrO₂•-•<•2.7° | ATZ•(10•~•16° | ATZ•(10•~•16° | ZrO₂•-•4•~•10° | ZrO₂•-•<•2.7° | ¤ |
| | mol %• | wt %• | wt %• | wt %• | mol %• | |
| | Y₂O₃•¶ | Al₂O₃)¤ | Al₂O₃)¤ | Y₂O₃•+•HfO₂¶ | Y₂O₃¶ | |
| | ¤ | | | ¤ | ¤ | |
| Pigment¤ | 4° wt %•oxides• | 4° wt %•oxides• | 5° wt %•oxides• | 4° wt %•oxides• | 10° wt %•oxides• | ¤ |
| | (Co, •Fe, •Cr)¤ | (Co, •Al)¤ | (Co, •Al)¤ | (Co, •Al)¤ | (Al)¤ | |
| Hardness¶ | 1197¤ | 1234¤ | 1245¤ | 1194¤ | 1286¤ | ¤ |
| (HV30)¤ | | | | | | |
| Toughness¶ | 14.0¤ | 12.7¤ | 12.5¤ | 14.4¤ | 15.5¤ | ¤ |
| (MPa√m)¤ | | | | | | |
| Colour¶ | L = 45.00¶ | L = 50.09¶ | L = 50.7¶ | L = 45.95¶ | L = 97.8¶ | ¤ |
| L, a, b¤ | a = −0.05¶ | a = −4.02¶ | a = 0.4¶ | a = −2.14¶ | a = −0.3¶ | |
| | b = −0.9•¤ | b = −17.62¤ | b = −29.39¤ | b = −3.23¤ | b = 1.07¤ | |

1. A coloured article made of a ceramic and comprising:
a so-called high-performance zirconia, present at between 80% and 99.5% by weight based on the total weight of the ceramic, the high-performance zirconia being selected from one or more of the following zirconias:
an yttrium oxide-doped zirconia, the molar percentage of yttrium oxide relative to the zirconia being less than 2.7%,
a cerium oxide and yttrium oxide co-doped zirconia, the total molar percentage of the cerium oxide with the yttrium oxide relative to the zirconia being between 1 and 12%,
a hafnium oxide and yttrium oxide co-doped zirconia, the total molar percentage of the hafnium oxide with the yttrium oxide relative to the zirconia being between 4 and 8%,
a zirconia doped with one or more oxides selected from an yttrium oxide, a cerium oxide, a magnesium oxide and a calcium oxide, and reinforced with an alumina, the percentage by weight of the alumina relative to the doped zirconia being between 8 and 18%,
pigments, present at between 2.5% and 20% by weight based on the total weight of the ceramic, said pigments containing one or more oxides selected from the list consisting of Al, Si, Fe, Cu, Co, Ni, Mn, Zn, Cr, Ti, Ce, V, Pr and Nd oxides, including mixed oxides from this list,
any impurities present at between 0 and 0.2% by weight,
the total percentage by weight of the high-performance zirconia, pigments and any impurities being 100%, said ceramic having a hardness HV30 greater than 1100 HV and a toughness greater than 12 MPav√m and the article having a L* component greater than 40, preferably greater than 45 in the CIELAB colour space.

2. The article according to claim 1, wherein the pigments are present at between 2.5% and 20% by weight.

3. The article according to claim 1, wherein the article has a black or blue colour and wherein the pigments contain one or more oxides chosen from the list consisting of Al, Fe, Co, Cr, Ni and Mn oxides, including the mixed oxides of this list, at between 3 and 7% by weight in total.

4. The article according to claim 3, wherein the article has a black colour and wherein the pigments are formed by Co, Fe and Cr oxides including mixed Co, Fe and Cr oxides with between 3% and 6% by weight, preferably between 3% and 5% by weight.

5. The article according to claim 4, wherein the high-performance zirconia is zirconia lightly doped with yttrium oxide.

6. The article according to claim 4, wherein the article has an L* component greater than 40 in the CIELAB colour space.

7. The article according to claim 3, wherein the article has a blue colour and wherein the pigments are formed by Co and Al oxides including mixed Co and Al oxides with between 3% and 7% by weight.

8. The article according to claim 7, wherein the high-performance zirconia is zirconia doped with one or more oxides chosen from yttrium oxide, cerium oxide, magnesium oxide and calcium oxide and reinforced with alumina or zirconia co-doped with hafnium oxide and yttrium oxide.

9. The article according to claim 1, wherein the article has a white colour and wherein the pigments contain Al and/or TI oxides including mixed Al and Ti oxides, at between 5 and 20% by weight in total.

10. The article according to claim 9, wherein the pigments are formed by Al oxide at between 6% and 14% by weight.

11. The article according to claim 9, wherein the high-performance zirconia is zirconia doped with yttrium oxide.

12. The article according to claim 9, wherein the article has an L* component greater than 90 in the CIELAB colour space.

13. The article according to claim 1, wherein the article is a timepiece component of the external part or movement.

14. The article according to claim 1, wherein the article is a dial (1).

15. A method for manufacturing an article according to claim 1, comprising the following steps of:
step a): preparing a base mixture, also referred to as the first mixture, with the high-performance zirconia and the pigments at the proportions according to claim 1, optionally in a liquid medium,
step b): producing a second mixture comprising the first mixture and an organic binder system,
step c): granulating the second mixture,
step d): forming a bank in the shape of the article,
step e): removing the binder from the blank,
step f): sintering the blank, in air, at a holding temperature of between 1200° C. and 1600° C. for a period of between 20 minutes and 20 hours.

16. The method according to claim 17, wherein sintering is followed by heat treatment in a vacuum or controlled atmosphere at a temperature of between 900° C. and 1200° C. with a plateau of between 20 minutes and 6 hours.
